(19) United States
(12) Patent Application Publication
(10) Pub. No.: US 2012/0166512 A1
(43) Pub. Date: Jun. 28, 2012

(54) High speed design for division & modulo operations

(75) Inventors: Yuen Wong, San Jose, CA (US); Hui Zhang, Cupertino, CA (US)

(73) Assignee: Foundry Networks, Inc., Santa Clara, CA (US)

(21) Appl. No.: 12/029,191

(22) Filed: Feb. 11, 2008

Related U.S. Application Data
(60) Provisional application No. 60/987,005, filed on Nov. 9, 2007.

(51) Int. Cl. G06F 7/44

(52) U.S. Cl. 708/650

(57) ABSTRACT

Techniques for efficiently performing division and modulo operations in a programmable logic device. In one set of embodiments, the division and modulo operations are synthesized as one or more alternative arithmetic operations, such as multiplication and/or subtraction operations. The alternative arithmetic operations are then implemented using dedicated digital signal processing (DSP) resources, rather than non-dedicated logic resources, resident on a programmable logic device. In one embodiment, the programmable logic device is a field-programmable gate array (FPGA), and the dedicated DSP resources are pre-fabricated on the FPGA. Embodiments of the present invention may be used in Ethernet-based network devices to support the high-speed packet processing necessary for 100G Ethernet, 32-port (or greater) trunking, 32-port/path (or greater) load balancing (such as 32-path ECMP), and the like.

### CROSS-REFERENCES TO RELATED APPLICATIONS

The present application claims the benefit and priority under 35 U.S.C. 119(e) from U.S. Provisional Application No. 60/987,005 (Atty. Docket No. 019959-005300US), entitled “HIGH SPEED DESIGN FOR DIVISION & MODULO OPERATIONS” filed Nov. 9, 2007, the entire contents of which are herein incorporated by reference for all purposes.

### BACKGROUND OF THE INVENTION

Embodiments of the present invention relate to data processing, and more particularly relate to techniques for efficiently performing division and modulo operations in a programmable logic device.

In the field of data communications, division and modulo operations are commonly performed in networking hardware such as switches, routers, host network interfaces, and the like for a variety of purposes. For example, Ethernet-based routers and switches execute division/modulo operations on incoming network packets to implement port trunking and port/path load balancing (e.g., equal cost multiple path routing (ECMP)).

However, division and modulo operations have traditionally been difficult to implement efficiently in hardware. In one common prior art approach, these operations are implemented using an iterative, “pencil and paper” technique in which the quotient and remainder are calculated through a series of iterations until a desired precision is reached. Unfortunately, this approach consumes a relatively large number of gates on a logic circuit, resulting in limited performance and scalability. As a result, prior art division/modulo techniques cannot effectively scale to support the high-speed packet processing required for 100G (i.e., 100 Gigabits per second) Ethernet, 32-port (or greater) trunking, 32-port/path (or greater) load balancing (such as 32-path ECMP), and the like.

Accordingly, it is desirable to have improved techniques for executing division and modulo operations that can be implemented in hardware in an efficient and performance-oriented manner.

### BRIEF SUMMARY OF THE INVENTION

Embodiments of the present invention provide techniques for efficiently performing division and modulo operations in a programmable logic device. In one set of embodiments, the division and modulo operations are synthesized as one or more alternative arithmetic operations, such as multiplication and/or subtraction operations. The alternative arithmetic operations are then implemented using dedicated digital signal processing (DSP) resources, rather than non-dedicated logic resources, resident on a programmable logic device. In one embodiment, the programmable logic device is a field-programmable gate array (FPGA), and the dedicated DSP resources are pre-fabricated on the FPGA. Embodiments of the present invention may be used in Ethernet-based network devices to support the high-speed packet processing necessary for 100G Ethernet, 32-port (or greater) trunking, 32-port/path (or greater) load balancing (such as 32-path ECMP), and the like.

According to one set of embodiments, a method for performing a division operation in a programmable logic device is provided. The method comprises determining a reciprocal of a denominator value, and generating a first intermediate product by multiplying the reciprocal with a numerator value. In various embodiments, the step of multiplying is performed using one or more dedicated digital signal processing (DSP) resources resident on the programmable logic device. A quotient is then generated based on the first intermediate product.

In one embodiment, a method for performing a modulo operation in a programmable logic device comprises the steps above. The method further comprises generating a second intermediate product by multiplying the quotient with the denominator value, and generating a remainder by subtracting the second intermediate product from the numerator value. In various embodiments, the steps of multiplying the quotient with the denominator value and subtracting the second intermediate product from the numerator value are performed using the one or more dedicated DSP resources resident on the programmable logic device.

In one embodiment, the steps of determining the reciprocal, generating the first intermediate product, and generating the quotient do not require the use of non-dedicated logic resources resident on the programmable logic device.

In one embodiment, generating the quotient based on the first intermediate product comprises truncating the first intermediate product. This truncation may be performed by bitwise-shifting the first intermediate product.

In one embodiment, determining the reciprocal of the denominator value comprises accessing a lookup table configured to store reciprocals for a predefined range of denominator values. The lookup table may be implemented in a dedicated Read Only Memory (ROM) portion of the programmable logic device, or in a non-dedicated logic portion of the programmable logic device.

In one embodiment, the division and modulo operations described above are pipelined.

In one embodiment, the logic device is an FPGA, and is configured to perform Ethernet packet processing in an Ethernet-based network device. The Ethernet-based network device may be configured to support data transmission speeds of at least 10 Gigabits per second (Gbps), at least 100 Gbps, or greater.

According to another set of embodiments, a method for processing network packets in a network device is provided. The method comprises receiving a network packet at a packet processor of the network device, where the packet processor includes a plurality of non-dedicated logic blocks and a plurality of dedicated DSP blocks. The method further comprises processing the network packet at the packet processor, where the processing includes performing a division operation on a portion of the network packet by determining a reciprocal of a denominator value, generating a first intermediate product by multiplying the reciprocal with a numerator value, and generating a quotient based on the first intermediate product. In various embodiments, the step of multiplying is performed using at least one of the plurality of dedicated DSP blocks.

In one embodiment, the processing further includes performing a modulo operation on the portion of the network packet by generating a second intermediate product by multiplying the quotient with the denominator value, and generating a remainder by subtracting the second intermediate product from the numerator value. In various embodiments, the steps of multiplying the quotient with the denominator value and subtracting the second intermediate product from the numerator value are performed using one or more additional DSP blocks in the plurality of dedicated DSP blocks.

In one embodiment, the steps of determining the reciprocal, generating the first intermediate product, and generating the quotient do not require the use of the plurality of non-dedicated logic blocks.

In one embodiment, the packet processor is configured to support a data throughput rate of at least 10 Gbps. In other embodiments, the packet process is configured to support a data throughput rate of at least 100 Gbps.

According to another set of embodiments, a method for programming an FPGA is provided. The method comprises providing an FPGA including non-dedicated logic resources and dedicated DSP resources, and programming the FPGA to perform division and/or modulo operations using at least a portion of the dedicated DSP resources. In various embodiments, the division and/or modulo operations are performed without using the non-dedicated logic resources.

According to another set of embodiments, a packet processor for a network device is provided. The packet processor comprises an FPGA including a dedicated DSP portion and a non-dedicated logic portion. The FPGA is configured to process a received network packet. Further, the dedicated DSP portion is configured to perform a division and/or modulo operation based on a portion of the received network packet. In various embodiments, the division and/or modulo operation is performed without using the non-dedicated logic portion. In one embodiment, the packet processor is a media access controller (MAC).

According to another set of embodiments, a network device is provided. The network device comprises one or more ports for receiving network packets, and a processing component for processing a received network packet. The processing includes performing a division and/or modulo operation based on a portion of the received network packet using a dedicated DSP resource resident on the processing component. In various embodiments, the division and/or modulo operation is performed without using non-dedicated logic resources resident on the processing component. In one embodiment, the network device is an Ethernet-based network switch.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a system that may incorporate an embodiment of the present invention.

FIG. 2 is a simplified block diagram of a network environment that may incorporate an embodiment of the present invention.

FIG. 3 is a flowchart illustrating the steps performed in executing a division operation in a programmable logic device in accordance with an embodiment of the present invention.

FIG. 4 is a flowchart illustrating the steps performed in executing a modulo operation in a programmable logic device in accordance with an embodiment of the present invention.

FIGS. 5A and 5B are simplified block diagrams illustrating a logic circuit configured to execute a division and/or modulo operation in accordance with an embodiment of the present invention.

### DETAILED DESCRIPTION OF THE INVENTION

In the following description, for the purposes of explanation, numerous specific details are set forth in order to provide an understanding of the present invention. It will be apparent, however, to one skilled in the art that the present invention may be practiced without some of these specific details.

Embodiments of the present invention provide techniques for efficiently performing division and modulo operations in a programmable logic device such as an FPGA. According to one set of embodiments, the division and modulo operations are synthesized as one or more alternative arithmetic operations. For example, the division operation is synthesized by multiplying the numerator value (i.e., dividend) with the reciprocal of the denominator value (i.e., divisor). This multiplication generates a quotient. Further, the modulo operation is synthesized by multiplying the quotient with the denominator value, and subtracting the resultant product from the numerator value.

Converting division and modulo operations to alternative arithmetic operations (such as multiplication and/or subtraction as described above) enables the operations to be implemented using dedicated digital signal processing (DSP) resources, rather than non-dedicated logic resources, resident on a programmable logic device. Generally speaking, the dedicated DSP resources resident on a programmable logic device such as an FPGA are optimized for executing multiplication, addition, and subtraction operations (but not for executing division or modulo operations). Accordingly, by using these dedicated DSP resources to implement division/modulo in the manner described above, performance and scalability are improved over prior art approaches. In addition, the non-dedicated logic resources resident on the programmable logic device, which would be otherwise used for performing division and module operations, are freed for implementing other logic functions.

The division and modulo techniques described herein may be applied to a variety of different domains and contexts. In one embodiment, the techniques may be used in the networking or data communication domain. In a networking environment, the division and modulo techniques may be employed by network devices such Ethernet-based routers, switches, hubs, host network interfaces, and the like to facilitate high-speed packet processing. Due to the enhanced performance, embodiments of the present invention enable such network devices to support high-speed packet processing required for high data transmission rates such as 10 Gbps, 100 Gbps, and beyond. Further, embodiments of the present invention enable such network devices to support high performance uniform resource handling such as 32-port (or greater) trunking, 32-port/path (or greater) load balancing (such as 32-path ECMP), and the like.

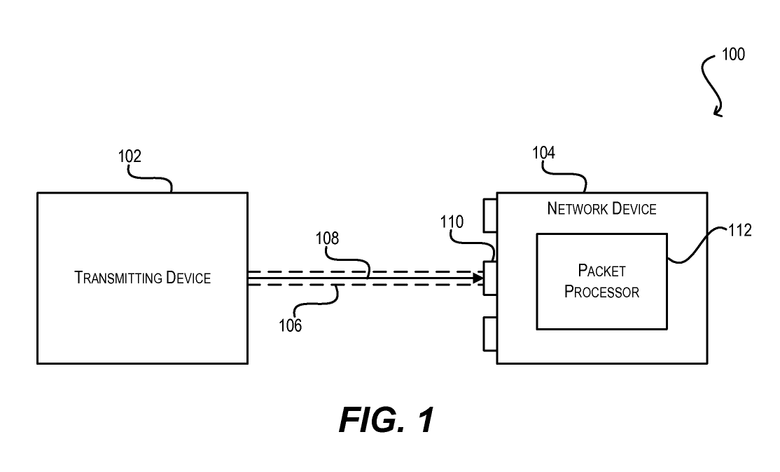

FIG. 1 is a simplified block diagram of a system that may incorporate an embodiment of the present invention. As shown, system 100 comprises a transmitting device 102 coupled to a receiving network device 104 via a data link 106. Receiving network device 104 may be a router, switch, hub, host network interface, or the like. In one embodiment, network device 104 is an Ethernet-based network switch, such as network switches provided by Foundry Networks, Inc. of Santa Clara, Calif., or the switches described in U.S. Pat. Nos. 7,187,687, 7,206,283, 7,266,117, and 6,901,072, which are incorporated herein by reference in their entireties for all purposes. Network device 104 may be configured to support data transmission speeds of at least 10 Gbps, at least 100 Gbps, or greater.

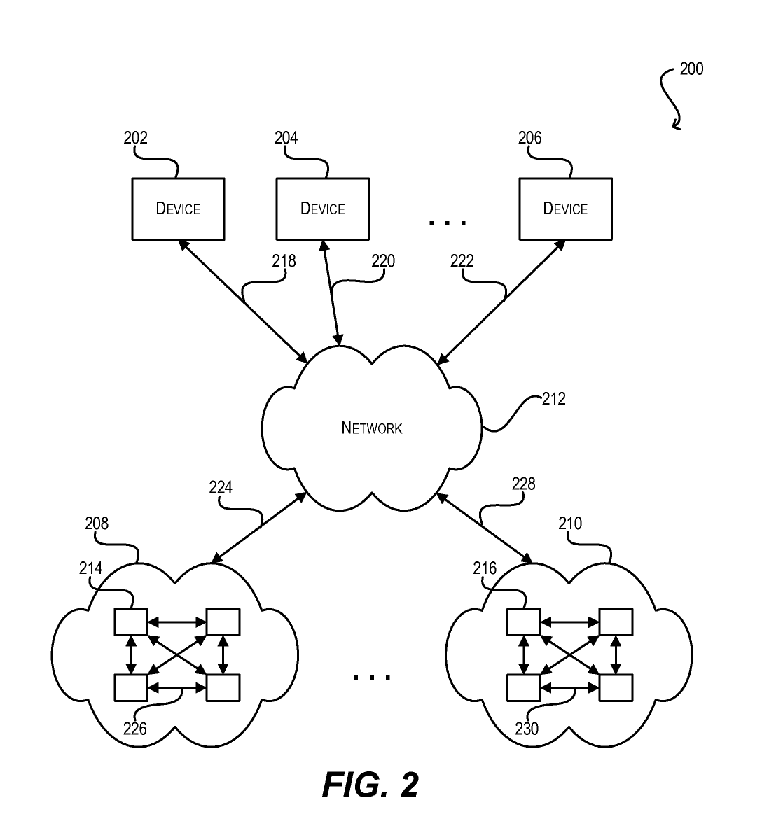

Transmitting device 102 may also be a network device, or may be some other hardware and/or software-based component capable of transmitting data. Although only a single transmitting device and receiving network device are shown in FIG. 1, it should be appreciated that system 100 may incorporate any number of these devices. Additionally, system 100 may be part of a larger system environment or network, such as a computer network (e.g., a local area network (LAN), wide area network (WAN), the Internet, etc.) as shown in FIG. 2.

Transmitting device 102 may transmit a data stream 108 to network device 104 using data link 106. Data link 106 may be any transmission medium, such as a wired (e.g., optical, twisted-pair copper, etc.) or wireless (e.g., 802.11, Bluetooth, etc.) link. Various different protocols may be used to communicate data stream 108 from transmitting device 102 to receiving network device 104. In one embodiment, data stream 108 comprises discrete messages (e.g., Ethernet frames, IP packets) that are transmitted using a network protocol (e.g., Ethernet, TCP/IP, etc.).

Network device 104 may receive data stream 108 at one or more ports 110. The data stream received over a port 110 may then be routed to a packet processor 112, such as a Media Access Controller (MAC) as found in Ethernet-based networking equipment. Although not shown, packet processor 112 may be coupled to various memories, such as an external Content Addressable Memory (CAM) or external Random Access Memory (RAM). In one embodiment, packet processor 112 matches portions of a received network packet within data stream 108 to CAM entries, which point to locations in RAM. The locations store information used by packet processor 112 in processing the packet.

Packet processor 112 may be implemented as one or more FPGAs and/or application-specific integrated circuits (ASICs). As an FPGA, packet processor 112 may include non-dedicated logic resources and dedicated DSP resources. The non-dedicated logic resources are configurable and may be programmed to perform any one of a plurality of logic functions. In contrast, the dedicated DSP resources are generally not configurable to the same extent as the logic resources, and are pre-fabricated to facilitate certain arithmetic operations. For example, a programmable logic device such as an FPGA typically includes dedicated DSP resources optimized to perform multiplication, subtraction, and addition operations (but not division or modulo operations).

In various embodiments, packet processor 112 is configured to perform a variety of processing operations on data stream 108. These operations may include buffering of the data stream for forwarding to other components in the network device, updating header information in a message, determining a next destination for a received message, and the like.

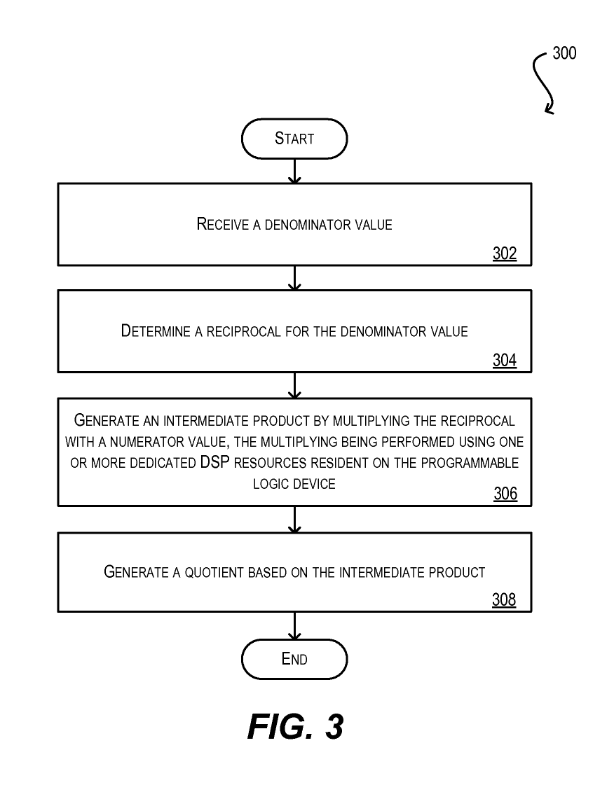

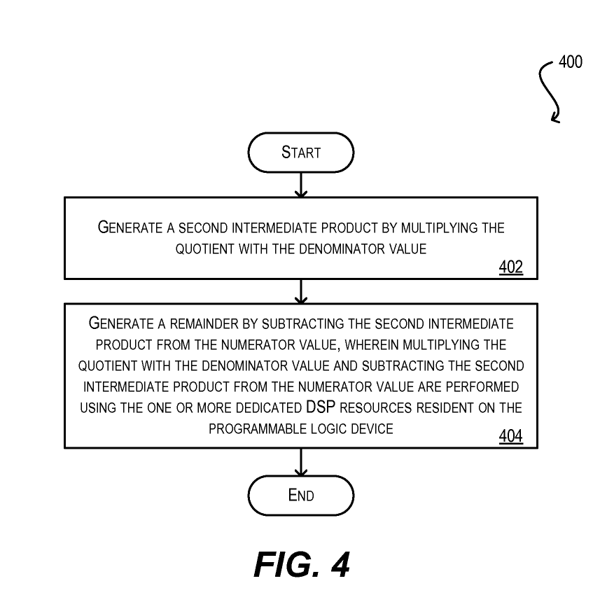

According to one set of embodiments, packet processor 112 is configured to perform division and/or modulo operations based on at least portions of packets in data stream 108. These division and modulo operations may be used, for example, to facilitate port/path load balancing (such as ECMP) or port trunking. In one embodiment of the present invention, the division and modulo operations are implemented using the dedicated DSP resources, rather than the non-dedicated logic resources, resident on packet processor 112. This approach may also utilize a dedicated Read Only Memory (ROM) portion embedded in packet processor 112 as a lookup table. This implementation provides for increased speed and reduced gate count over implementations built using the non-dedicated logic resources as primitives. The enhanced performance and the size savings are particularly important for FPGA-based logic devices, which are inherently limited in performance and size when compared to ASIC designs. One technique for implementing division and modulo operations using dedicated DSP resources is discussed in greater detail with respect to FIGS. 3 and 4 below.

FIG. 2 is a simplified block diagram of a network environment that may incorporate an embodiment of the present invention. Network environment 200 may comprise any number of transmitting devices, data links, and receiving devices as described above with respect to FIG. 1. As shown, network environment 200 includes a plurality network devices 202, 204, 206 and a plurality of sub-networks 208, 210 coupled to a network 212. Additionally, sub-networks 208, 210 include one or more nodes 214, 216.

Network devices 202, 204, 206 and nodes 214, 216 may be any type of device capable of transmitting or receiving data via a communication channel, such as a router, switch, hub, host network interface, and the like. Sub-networks 208, 210 and network 212 may be any type of network that can support data communications using any of a variety of protocols, including without limitation Ethernet, ATM, token ring, FDDI, 802.11, TCP/IP, IPX, and the like. Merely by way of example, sub-networks 208, 210 and network 212 may be a LAN, a WAN, a virtual network (such as a virtual private network (VPN)), the Internet, an intranet, an extranet, a public switched telephone network (PSTN), an infra-red network, a wireless network, and/or any combination of these and/or other networks.

Data may be transmitted between any of network devices 202, 204, 206, sub-networks 208, 210, and nodes 214, 216 via one or more data links 218, 220, 222, 224, 226, 228, 230. Data links 218, 220, 222, 224, 226, 228, 230 may be configured to support the same or different communication protocols. Further, data links 218, 220, 222, 224, 226, 228, 230 may support the same or different transmission standards (e.g., 10G Ethernet for links 218, 229, 222 between network devices 202, 204, 206 and network 212, 100G Ethernet for links 226 between nodes 214 of sub-network 208).

In one embodiment, at least one data link 218, 220, 222, 224, 226, 228, 230 is configured to support 100G Ethernet. Additionally, at least one device connected to that link (e.g., a receiving device) is configured to support a data throughput of at least 100 Gbps. In this embodiment, the receiving device may correspond to receiving network device 104 of FIG. 1, and may incorporate a packet processor 112 implementing division and modulo techniques as described herein.

FIG. 3 is a flowchart 300 illustrating the steps performed in executing a division operation in a programmable logic device in accordance with an embodiment of the present invention. The processing of flowchart 300 is merely illustrative of an embodiment of the present invention and is not intended to limit the scope of the invention. In one embodiment, flowchart 300 is performed by an FPGA-based packet processor of a network device, such as packet processor 112 of FIG. 1.

At step 302, a denominator value for the division operation is received. In one embodiment, the denominator value is taken from a portion of a received network packet for the purpose of performing one or more packet processing operations. For example, the denominator value may be taken from the header of the packet to perform port trunking or port/path load balancing (such as ECMP). In alternative embodiments, the denominator value may be based on other data or criteria (e.g., total number ports being load balanced, etc.).

Once the denominator value has been received, a reciprocal for the denominator value is determined (step 304). As described above, a division operation may be synthesized as a multiplication of the numerator value with the reciprocal of the denominator value. In various embodiments, the reciprocal is retrieved from a lookup table storing reciprocals for a predetermined range of denominator values. For example, the lookup table may store reciprocals for integer denominator values up to 8-bits long (i.e., up to 256). Of course, the lookup table may be configured to store reciprocals for a larger or smaller range of denominator values as appropriate for a particular application. In one embodiment, the lookup table may be implemented in a dedicated ROM portion of the programmable logic device. This dedicated ROM portion may be a pre-fabricated, embedded memory. In another embodiment, the lookup table may be implemented in a non-dedicated logic portion of the programmable logic device. In yet another embodiment, the lookup table may be implemented in a memory external to the programmable logic device.

At step 306, an intermediate product is generated by multiplying the reciprocal with the numerator value. Like the denominator value, the numerator value may be taken from a portion of a received network packet, or may be derived based on other data/criteria. Significantly, the multiplication is performed using a dedicated DSP resource resident on the programmable logic device. This implementation leverages the capability of dedicated DSP resources to execute arithmetic instructions such as multiplication in a highly optimized manner. This approach also conserves non-dedicated logic resources resident on the programmable logic device for other logic functions. In the case of a network switch, such other logic functions may include packet processing operations other than division or modulo.

At step 308, a quotient for the division operation is generated based on the intermediate product generated at step 306. If the intermediate product is an integer value (indicating no remainder), the intermediate product corresponds to the quotient. However, if the intermediate product is a non-integer value, the intermediate product may be truncated to generate the quotient. In one set of embodiments, the intermediate product may be truncated by bitwise-shifting the intermediate product until the non-integer bits have been removed. In one embodiment, this shifting operation is implemented by a shifter included in one or more dedicated DSP resources resident on the programmable logic device, such as the dedicated DSP resource described with respect to step 306.

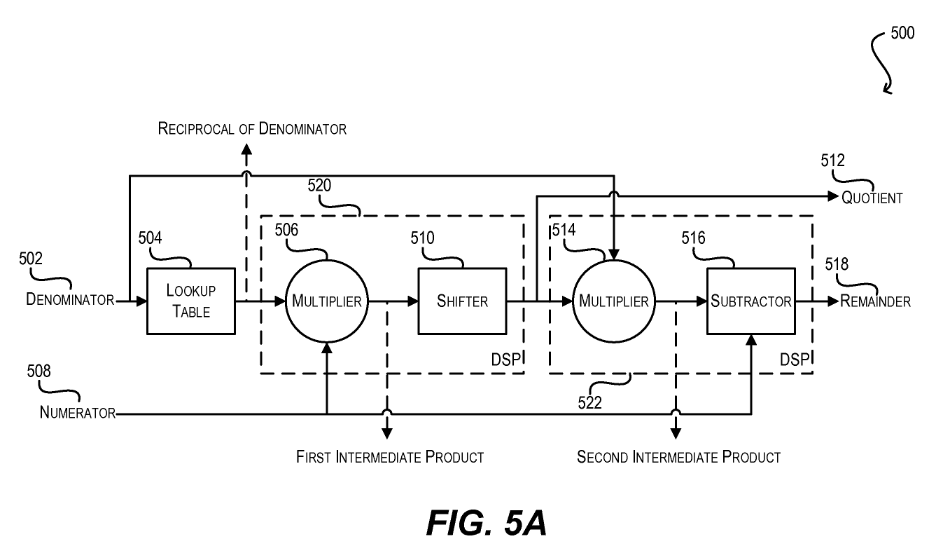

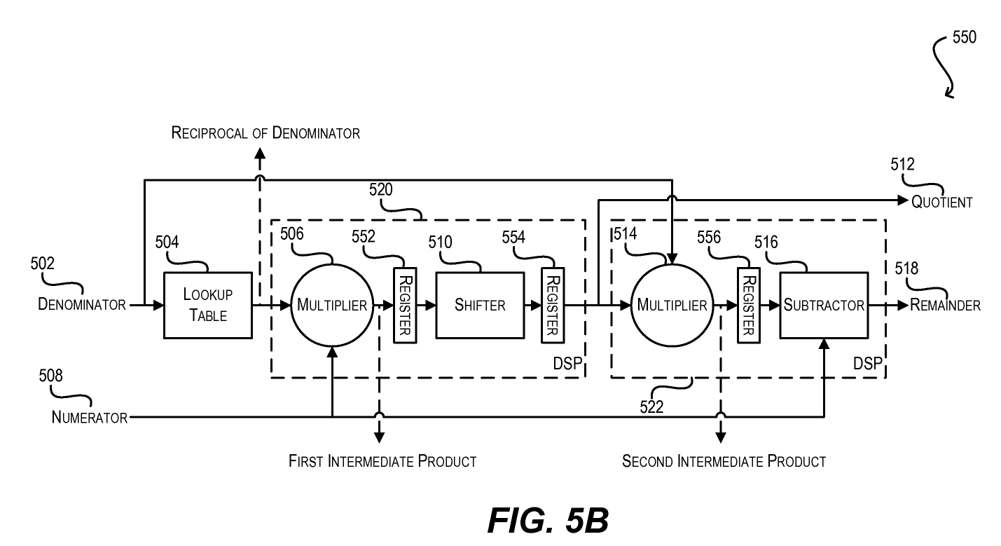

Although not shown, the processing of flowchart 300 may be pipelined to improve the data throughput of the programmable logic device. For example, pipeline registers may be used to store the generated intermediate product and/or the generated quotient at each clock cycle. One pipelined implementation of flowchart 300 is discussed in greater detail with respect to FIG. 5B below.

In various embodiments, the steps of flowchart 300 are wholly implemented using the dedicated DSP resources resident on the programmable logic device. In other words, non-dedicated logic resources are not consumed by this implementation. Thus, the performance and scalability of the programmable logic device in performing division operations is significantly improved over prior art methods. In some embodiments, a relatively small amount of non-dedicated logic resources may be used to, for example, implement the reciprocal lookup table, or to cascade DSP blocks in the case of very large numerator and/or denominator values. However, even in these embodiments, performance and scalability will be improved.

It should be appreciated that the specific steps illustrated in FIG. 3 provide a particular method for performing a division operation in a programmable logic device according to an embodiment of the present invention. Other sequences of steps may also be performed according to alternative embodiments. For example, the individual steps illustrated in FIG. 3 may include multiple sub-steps that may be performed in various sequences as appropriate to the individual step. Further, additional steps may be added or removed depending on the particular applications. One of ordinary skill in the art would recognize many variations, modifications, and alternatives.

FIG. 4 is a flowchart 400 illustrating the steps performed (in addition to the steps of flowchart 300) in executing a modulo operation in a programmable logic device in accordance with an embodiment of the present invention. The processing of flowchart 400 is merely illustrative of an embodiment of the present invention and is not intended to limit the scope of the invention. In one embodiment, flowchart 400 is performed by an FPGA-based packet processor of a network device, such as packet processor 112 of FIG. 1.

As described above, a modulo operation may be synthesized by multiplying the quotient of the corresponding division operation with the denominator value, and then subtracting the resultant product from the numerator value. Accordingly, at step 402, a second intermediate product is generated by multiplying the quotient generated in step 308 of FIG. 3 with the denominator value. A remainder is then generated by subtracting the second intermediate product from the numerator value (step 404).

In one set of embodiments, the steps of multiplying the quotient with the denominator value and subtracting the second intermediate product from the numerator value are performed using one or more dedicated DSP resources resident on the programmable logic device. Like flowchart 300, the steps of flowchart 400 may be implemented without consuming any non-dedicated logic resources. In one embodiment, these steps may be performed using the same dedicated DSP resource used to perform steps 306, 308 of FIG. 3. In alternative embodiments, these steps may be performed using one or more additional DSP resources.

It should be appreciated that the specific steps illustrated in FIG. 4 provide a particular method for performing a modulo operation in a programmable logic device according to an embodiment of the present invention. Other sequences of steps may also be performed according to alternative embodiments. For example, the individual steps illustrated in FIG. 4 may include multiple sub-steps that may be performed in various sequences as appropriate to the individual step. Further, additional steps may be added or removed depending on the particular applications. One of ordinary skill in the art would recognize many variations, modifications, and alternatives.

FIG. 5A is a simplified block diagram of a logic circuit 500 configured to execute a division and modulo operation in accordance with an embodiment of the present invention. Specifically, logic circuit 500 represents one possible hardware-based implementation of flowcharts 300 and 400. In one set of embodiments, the functionality of logic circuit 500 may be programmed into an FPGA comprising dedicated DSP resources and non-dedicated logic resources. Further, logic circuit 500 may be implemented in a packet processor of an Ethernet-based network device, such as packet processor 112 of FIG. 1.

As shown, circuit 500 receives as input a denominator value 502 and a numerator value 508. Denominator value 502 is passed to lookup table 504, where a reciprocal of the denominator value is determined. As described above, lookup table 504 may be implemented in a dedicated ROM portion of circuit 500, or a non-dedicated logic portion. Lookup table 504 may also be implemented in a memory external to circuit 500.

The reciprocal and the numerator value are then passed into DSP block 520. In various embodiments, DSP block 520 is pre-fabricated onto the die/chip containing logic circuit 500, and is optimized to perform multiplication using multiplier 506. Further, DSP block is optimized to perform bitwise-shifting using shifter 510. As shown, multiplier 506 receives the reciprocal from lookup table 504 and numerator value 508, and generates a first intermediate product. The first intermediate product is then passed to shifter 510, which generates the quotient (512) for the division operation.

If a modulo operation is not being performed, quotient 512 is output by circuit 500. If a modulo operation is being performed, quotient 512 (along with denominator value 502 and numerator value 508) is passed to a second DSP block 522. Like DSP block 520, DSP block 522 is pre-fabricated onto the die/chip containing logic circuit 500. Further, DSP block 522 is optimized to perform multiplication using multiplier 514, and subtraction using subtractor 516. In one set of embodiments, DSP block 522 may be identical to DSP block 520. Accordingly, DSP block 522 may include a shifter (not shown) such as shifter 510, and DSP block 520 may include a subtractor (not shown) such as subtractor 516. In other embodiments, DSP blocks 520 and 522 may incorporate differing components.

As shown, multiplier 514 receives quotient 512 and denominator value 502, and generates a second intermediate product. The second intermediate product and numerator value 508 is then passed to subtractor 516, which generates the remainder 518 for the modulo operation.

It should be appreciated that circuit 500 illustrates one possible logic circuit for performing division/modulo operations, and other alternative configurations are contemplated. For example, although multiplier 506 and shifter 510 are shown as being resident in one DSP block (520), and multiplier 514 and subtractor 516 are shown as being resident in a second DSP block (522), components 506, 510, 514, 516 may be resident in a single DSP block. Alternatively, each component 506, 510, 514, 516 may be resident in separate DSP blocks. In addition. multiple DSP blocks may be cascaded to support denominator and numerator values that go beyond the input data width of a single DSP block. One of ordinary skill in the art would recognize many variations, modifications, and alternatives.

In some embodiments, the processing of circuit 500 may be pipelined to improve data throughput for a given clock rate. FIG. 5B is a simplified block diagram illustrating a pipelined version 550 of logic circuit 500. As shown, circuit 550 is substantially similar to circuit 500 of FIG. 5A, but includes pipeline registers 552, 554, 556. Pipeline registers 552, 554, 556 are configured to store intermediate values for respective stages in the processing of circuit 550, thereby enabling pipelined operation. For example, pipeline register 552 is configured to store the first intermediate product generated by multiplier 506. Pipeline register 554 is configured to store quotient 512 generated by shifter 510. And pipeline register 556 is configured to store the second intermediate product generated by multiplier 514.

In one set of embodiments, pipeline registers 552, 554, 556 are included in respective DSP blocks 520, 522. Most modern FPGAs include such registers in their pre-fabricated DSP blocks specifically for pipelining. Accordingly, circuit 550 may be implemented without consuming any non-dedicated logic resources.

It should be appreciated that circuit 550 illustrates one possible pipelined circuit for performing division/modulo operations, and other alternative configurations are contemplated. For example, although four pipeline stages are shown, any number of pipeline stages may be supported. Further, pipeline registers 552, 554, 556 may be situated at different points in the data flow. One of ordinary skill in the art would recognize many variations, modifications, and alternatives.

The following table presents metrics for performing a modulo operation according to various embodiments of the present invention, as implemented on an Altera Stratix II EP2S180F1508C4 FPGA device. The first column displays the data width of the input numerator and denominator. The second column displays metrics for the prior art, iterative technique. The third column displays metrics for the prior art, iterative technique with a pipeline depth of four. The fourth column displays metrics for an embodiment of the present invention using a ROM-based lookup table. The fifth column displays metrics for an embodiment of the present invention using a logic-based (i.e., lut-based) lookup table. And the sixth column displays metrics for an embodiment of the present invention using a ROM-based lookup table and a pipeline depth of four.

For each cell in the table, the first section indicates the amount of resources consumed by the technique, and the second section indicates, in nanoseconds, the total amount of time required to complete the modulo operation. By way of example, for a numerator/denominator of 12 bits/6 bits and the prior art iterative technique, 131 lut (non-dedicated logic blocks) are consumed, and the timing is approximately 20 nanoseconds. In contrast, for the same numerator/denominator of 12 bits/6 bits and an embodiment of the present invention using a ROM lookup table, 2 kilobits of ROM and 12 DSP blocks are consumed, and the timing is reduced to approximately 13 nanoseconds. Cells for which no data is available are left blank.

| | | | | New | New technique |
|---|---|---|---|---|---|
| Numerator/ | | Iterative | New technique w/ | technique w/ | with ROM lookup |
| Denominator | Iterative | technique w/ | ROM lookup | lut lookup | table and pipeline |
| (bits) | technique | pipeline depth 4 | table | table | depth 4 |
| 8/5 | 69 lut | 72 lut | | | |
| | 12 ns | 67 registers | | | |
| | | 3.956 ns | | | |
| 12/6 | 131 lut | 134 lut | 2k ROM | | |
| | 20.446 ns | 91 registers | 12 DSP blocks | | |
| | | 6.025 ns | 13.29 ns | | |
| 16/6 | 187 lut | 187 lut | 2k ROM | | |
| | 29.203 ns | 108 registers | 12 DSP blocks | | |
| | | 7.539 ns | 13.29 ns | | |
| 18/6 | 215 lut | 218 lut | 2k ROM | | |
| | 31.095 ns | 117 registers | 12 DSP blocks | | |
| | | 8.648 ns | 13.34 ns | | |
| 20/6 | 243 lut | 246 lut | 2k ROM | | |
| | 35.697 ns | 125 registers | 24 DSP blocks | | |
| | | 9.578 ns | 7 lut (required for | | |
| | | | cascading DSPs) | | |
| | | | 16.162 ns | | |
| 36/6 | 411 lut | 482 lut | 2k ROM | 24 DSP blocks | 2k ROM |
| | 54.236 ns | 156 registers | 24 DSP blocks | 39 lut | 24 DSP blocks |
| | | 15.032 ns | 7 lut (required for | 16.180 ns | 7 lut (required for |
| | | | cascading DSPs) | | cascading DSPs) |
| | | | 15.762 ns | | 4.541 ns |
| 36/13 | 734 lut | 744 lut | 262k ROM | | 262k ROM |
| | 82.98 ns | 149 registers | 24 DSP blocks | | 24 DSP blocks |
| | | 19.394 ns | 46 lut (required for | | 49 lut (required for |
| | | | cascading DSPs) | | cascading DSPs) |
| | | | 16.88 ns | | 5 ns |

As described herein, embodiments of the present invention provide several significant advantages over prior art methods for performing division and modulo operations. For example, since dedicated DSP resources are typically performance-optimized and have deterministic timing, the speed of division and modulo operations is significantly improved. This speed increase is evident in the table above.

Further, the scalability of programmable logic devices implementing the techniques of the present invention are substantially enhanced. DSP blocks typically implement fixed-size multipliers and subtractors over a predefined range. Thus, the performance of division and modulo operations will not degrade if the width (i.e., size) of the numerator value or denominator value increase within that range. Additionally, increasing the size of the reciprocal lookup table will not significantly degrade performance when implemented in ROM, because ROM address to data-out timing is relatively stable.

Yet further, since DSP blocks are typically prefabricated as dedicated resources on programmable logic devices such as FPGAs, non-dedicated logic resources are conserved. This results in a significant reduction in gate count, and frees the non-dedicated logic resources for other processing functions.

Although specific embodiments of the invention have been described, various modifications, alterations, alternative constructions, and equivalents are also encompassed within the scope of the invention. For example, embodiments of the present invention may be applied to any data processing environment that requires efficient division and/or modulo calculations. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. For example, embodiments of the present invention are not restricted to implementation in FPGAs, and may be implemented in any type of logic device that includes dedicated DSP resources.

The specification and drawings are, accordingly, to be regarded in an illustrative rather than a restrictive sense. It will be evident that additions, subtractions, deletions, and other modifications and changes may be made thereunto without departing from the broader spirit and scope of the invention as set forth in the claims.

What is claimed is:

1. A method for performing a division operation in a programmable logic device, the method comprising:
determining a reciprocal of a denominator value;
generating a first intermediate product by multiplying the reciprocal with a numerator value, the multiplying being performed using one or more dedicated digital signal processing (DSP) resources resident on the programmable logic device; and
generating a quotient based on the first intermediate product.

2. A method for performing a modulo operation in a programmable logic device, wherein the method includes the steps of claim 1, and wherein the method further comprises:
generating a second intermediate product by multiplying the quotient with the denominator value; and
generating a remainder by subtracting the second intermediate product from the numerator value,
wherein multiplying the quotient with the denominator value and subtracting the second intermediate product from the numerator value are performed using the one or more dedicated DSP resources resident on the programmable logic device.

3. The method of claim 1, wherein determining the reciprocal, generating the first intermediate product, and generating the quotient do not require use of non-dedicated logic resources resident on the programmable logic device.

4. The method of claim 1, wherein generating the quotient based on the first intermediate product comprises truncating the first intermediate product.

5. The method of claim 4, wherein truncating the first intermediate product comprises bitwise-shifting the first intermediate product.

6. The method of claim 1, wherein determining the reciprocal of the denominator value comprises accessing a lookup table configured to store reciprocals for a predefined range of denominator values.

7. The method of claim 6, wherein the lookup table is implemented in a dedicated Read Only Memory (ROM) portion of the programmable logic device.

8. The method of claim 6, wherein the lookup table is implemented in a non-dedicated logic potion of the programmable logic device.

9. The method of claim 1, wherein the division operation is pipelined.

10. The method of claim 1, wherein the programmable logic device is a field-programmable gate array (FPGA).

11. The method of claim 10, wherein the FPGA is configured to perform Ethernet packet processing in an Ethernet-based network device, and wherein the Ethernet-based network device is configured to support data transmission speeds of at least 10 Gigabits per second (Gbps).

12. The method of claim 10, wherein the FPGA is configured to perform Ethernet packet processing in an Ethernet-based network device, and wherein the Ethernet-based network device is configured to support data transmission speeds of at least 100 Gbps.

13. A method for processing network packets in a network device, the method comprising:
receiving a network packet at a packet processor of the network device, wherein the packet processor includes a plurality of non-dedicated logic blocks and a plurality of dedicated DSP blocks; and
processing the network packet at the packet processor, wherein the processing includes performing a division operation based on a portion of the network packet by:
determining a reciprocal of a denominator value;
generating a first intermediate product by multiplying the reciprocal with a numerator value, the multiplying being performed using at least one of the plurality of dedicated DSP blocks; and
generating a quotient based on the first intermediate product.

14. The method of claim 13, wherein the processing further includes performing a modulo operation based on the portion of the network packet by:
generating a second intermediate product by multiplying the quotient with the denominator value; and
generating a remainder by subtracting the second intermediate product from the numerator value,
wherein multiplying the quotient with the denominator value and subtracting the second intermediate product from the numerator value are performed using one or more additional DSP blocks in the plurality of dedicated DSP blocks.

15. The method of claim 13, wherein determining the reciprocal, generating the first intermediate product, and generating the quotient do not require use of the plurality of non-dedicated logic blocks.

16. The method of claim 13, wherein the packet processor is configured to support a data throughput rate of at least 10 Gbps.

17. The method of claim 13, wherein the packet processor is configured to support a data throughput rate of at least 100 Gbps.

18. A method for programming an FPGA, the method comprising:
providing an FPGA including non-dedicated logic resources and dedicated DSP resources; and
programming the FPGA to perform division or modulo operations using at least a portion of the dedicated DSP resources, and without using the non-dedicated logic resources.

19. A packet processor for a network device comprising:
an FPGA including a dedicated DSP portion and a non-dedicated logic portion, wherein the FPGA is configured to process a received network packet, and wherein the dedicated DSP portion is configured to perform a division or modulo operation based on a portion of the received network packet.

20. The packet processor of claim 19, wherein the division or modulo operation is performed without using the non-dedicated logic portion.

21. The packet processor of claim 19, wherein the packet processor is a Media Access Controller (MAC).

22. A network device comprising:
one or more ports for receiving network packets; and
a processing component for processing a received network packet, wherein the processing includes performing a division or modulo operation based on a portion of a received network packet using a dedicated DSP resource resident on the processing component.

23. The network device of claim 22, wherein the division or modulo operation is performed without using non-dedicated logic resources resident on the processing component.

24. The network device of claim 22, wherein the network device is an Ethernet-based network switch.
